(19) United States
(12) Patent Application Publication
(10) Pub. No.: US 2023/0412772 A1
(43) Pub. Date: Dec. 21, 2023

(54) DATA ANALYSIS APPARATUS, METHOD, AND PROGRAM

(71) Applicant: Sony Group Corporation, Tokyo (JP)

(72) Inventors: Itaru SHIMIZU, Tokyo (JP); Tetsu OGAWA, Tokyo (JP); Naomi KURAHARA, Tokyo (JP)

(73) Assignee: Sony Group Corporation, Tokyo (JP)

(21) Appl. No.: 18/036,842

(22) PCT Filed: Nov. 5, 2021
(86) PCT No.: PCT/JP2021/040798

§ 371 Date: May 12, 2023

(30) Foreign Application Priority Data
Nov. 19, 2020 (JP) 2020-192526

(51) Int. Cl. H04N 7/18

(52) U.S. Cl. CPC H04N 7/183

(57) ABSTRACT

There is provided a data analysis apparatus capable of selecting observation data suitable for analysis of an image captured by a satellite, a method, and a program. The data analysis apparatus includes: a data acquisition unit configured to acquire a satellite image obtained by an artificial satellite imaging a predetermined place on a ground at a predetermined time and acquire ground data corresponding to a condition for capturing the satellite image from the ground data acquired on the ground; and an analysis processing unit configured to analyze the satellite image by using the acquired ground data and the acquired satellite image. The present technology can be applied to, for example, a satellite image processing system that uses the satellite image.

### TECHNICAL FIELD

The present technology relates to a data analysis apparatus, a method, and a program, and more particularly, to a data analysis apparatus capable of selecting observation data suitable for analysis of an image captured by a satellite, a method, and a program.

### BACKGROUND ART

Remote sensing is performed by an orbiting satellite equipped with a camera. Furthermore, for analysis of an image captured by a satellite, observation data obtained by observation with a sensor or the like on the ground is referred to (refer to, for example, Patent Documents 1 to 3).

### CITATION LIST

Patent Document
Patent Document 1: Japanese Patent Application Laid-Open No. 2003-151099
Patent Document 2: Japanese Patent Application Laid-Open No. 2020-080739
Patent Document 3: Japanese Patent Application Laid-Open No. 2019-087244

### SUMMARY OF THE INVENTION

### Problems to be Solved by the Invention

However, there is no guarantee that a timing at which the satellite image is captured coincides with a timing at which the observation data is acquired. For example, an orbiting satellite having a one-day prograde orbit can capture an image from the same sky position only once a day. On the other hand, the observation data is not always acquired, and an acquisition timing may be limited to several times a day.

The present technology has been made in view of such a situation, and enables selection of observation data suitable for analysis of an image captured by a satellite.

### Solutions to Problems

According to an aspect of the present technology, there is provided a data analysis apparatus including: a data acquisition unit configured to acquire a satellite image obtained by an artificial satellite imaging a predetermined place on a ground at a predetermined time and acquire ground data corresponding to a condition for capturing the satellite image from the ground data acquired on the ground; and an analysis processing unit configured to analyze the satellite image by using the acquired ground data and the acquired satellite image.

According to another aspect of the present technology, there is a data analysis method causing a data analysis apparatus to: acquire a satellite image obtained by an artificial satellite imaging a predetermined place on a ground at a predetermined time and acquire ground data corresponding to a condition for capturing the satellite image from the ground data acquired on the ground; and analyze the satellite image by using the acquired ground data and the acquired satellite image.

According to still another aspect of the present technology, there is provided a program causing a computer to execute processing, the processing including: acquiring a satellite image obtained by an artificial satellite imaging a predetermined place on a ground at a predetermined time and acquiring ground data corresponding to a condition for capturing the satellite image from the ground data acquired on the ground; and analyzing the satellite image by using the acquired ground data and the acquired satellite image.

In the aspect of the present technology, the satellite image obtained by the artificial satellite imaging the predetermined place on the ground at the predetermined time is acquired and the ground data corresponding to a condition for capturing the satellite image is acquired from the ground data acquired on the ground, and the satellite image is analyzed by using the acquired ground data and the acquired satellite image.

The data analysis apparatus according to the aspect of the present technology can be implemented by causing the computer to execute the program. The program executed by the computer can be provided by being transmitted via a transmission medium or by being recorded on a recording medium.

The data analysis apparatus may be an independent apparatus or may be an internal block which forms one apparatus.

### BRIEF DESCRIPTION OF DRAWINGS

FIG. 1 is a block diagram illustrating a configuration example of a satellite image processing system according to an embodiment to which the present technology is applied.

FIG. 2 is a block diagram illustrating a detailed configuration example of a satellite control system.

FIG. 3 is a block diagram illustrating a configuration example of a sensor device.

FIG. 4 is a block diagram illustrating a configuration example of a control device including a sensor device.

FIG. 5 is a diagram illustrating a data format example of sensor data.

FIG. 6 is a diagram illustrating an example of a representative collection method for ground data and satellite images.

FIG. 7 is a diagram for explaining collection of sensor data through a store-and-forward scheme.

FIG. 8 is a block diagram illustrating a configuration example of an image analysis apparatus.

FIG. 9 is a diagram illustrating an outline of first data analysis processing performed by a data analysis apparatus.

FIG. 10 is a diagram illustrating an outline of second data analysis processing performed by a data analysis apparatus.

FIG. 11 is a diagram illustrating an example of an acquisition timing of ground data and an acquisition timing of a satellite image.

FIG. 12 is a flowchart illustrating first analysis processing.

FIG. 13 is a flowchart illustrating first analysis processing using two-stage imaging.

FIG. 14 is a flowchart illustrating second analysis processing.

FIG. 15 is a flowchart illustrating a modification example of second analysis processing.

FIG. 16 is a conceptual diagram illustrating an application example of first and second analysis processing.

FIG. 17 is a block diagram illustrating a configuration example of a computer according to an embodiment to which the present technology is applied.

### MODE FOR CARRYING OUT THE INVENTION

Hereinafter, modes for carrying out the present technology (hereinafter, referred to as embodiments) will be described with reference to the accompanying drawings. Note that, in the present specification and the drawings, components having substantially the same functional configuration are denoted by the same reference numerals, and an overlapping description will be omitted. A description will be made in the following order.
1. Configuration Example of Satellite Image Processing System
2. Configuration Example of Satellite Control System
3. Configuration Example of Sensor Device
4. Collection Method For Ground Data and Satellite Images
5. Configuration Example of Data Analysis Apparatus
6. Acquisition Timing of Ground Data and Acquisition Timing of Satellite Image.
7. Example of First Analysis Processing using Ground Data as Complementary Data
8. Application Example of First Analysis Processing
9. Specific Example of First Analysis Processing
10. Example of Second Analysis Processing using Satellite Image Data as Complementary Data
11. Modification Example of Second Analysis Processing
12. Specific Example of Second Analysis Processing
13. Another Analysis Processing Example
14. Configuration Example of Computer

### 1. Configuration Example of Satellite Image Processing System

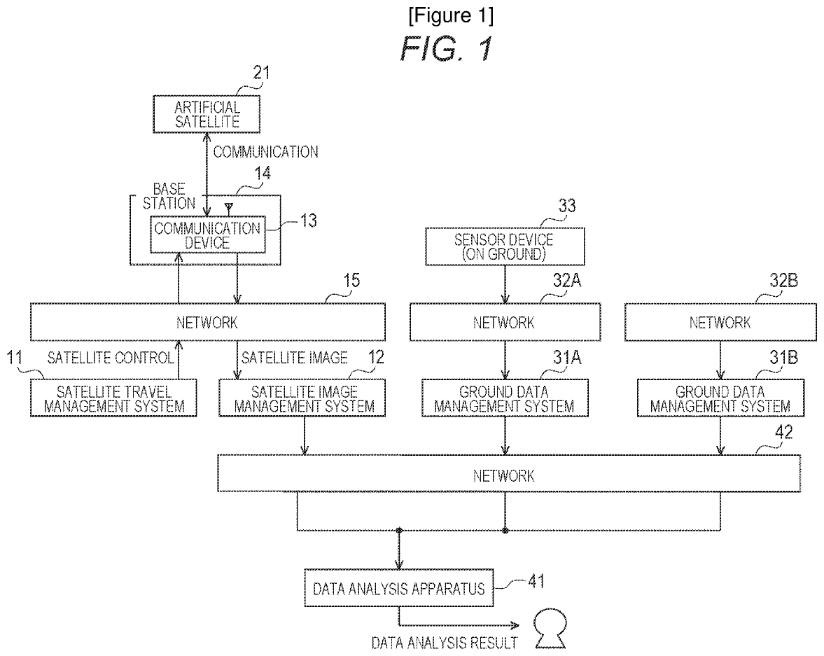

FIG. 1 is a block diagram illustrating a configuration example of a satellite image processing system according to an embodiment to which the present technology is applied.

A satellite image processing system 1 of FIG. 1 is a system in which analysis accuracy in analysis of a satellite image or ground data is improved by using a satellite image captured by an artificial satellite and observation data (hereinafter, it is referred to as ground data) acquired from the ground in a cooperation manner. In the present embodiment, the artificial satellite is an earth observation satellite, and has at least a function of imaging the ground with an equipped camera.

The satellite image processing system 1 includes, as a satellite control system that controls the artificial satellite, a satellite travel management system 11, a satellite image management system 12, a communication device 13, and an artificial satellite 21 (hereinafter, simply referred to as a satellite 21). The communication device 13 is disposed in a ground station (base station on the ground) 14. The satellite travel management system 11, the satellite image management system 12, and the communication device 13 are connected to each other via a network 15.

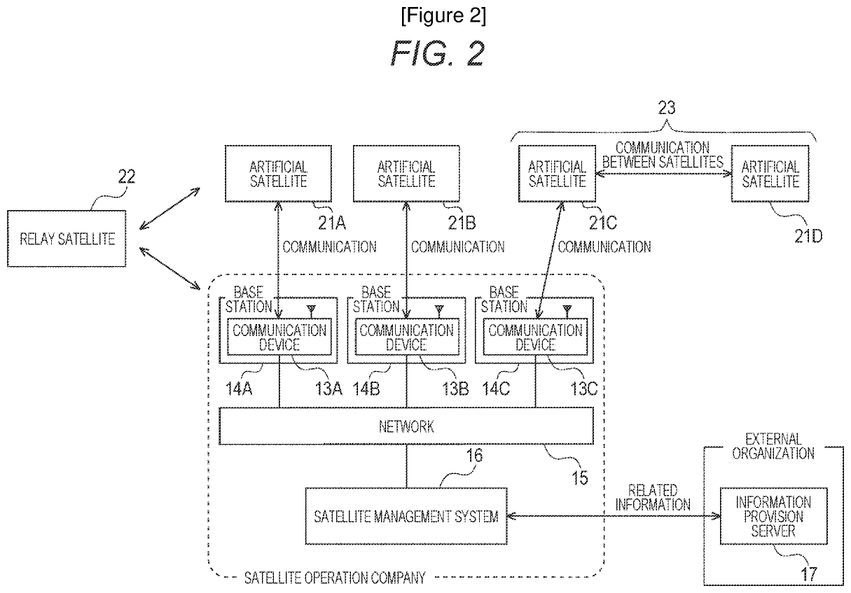

Note that, as will be described later with reference to FIG. 2, there are a plurality of the communication devices 13 and a plurality of the satellites 21, but only one communication device and only one satellite are illustrated in FIG. 1 for the sake of simplicity.

Furthermore, the satellite image processing system 1 includes, as a ground data acquisition system that acquires ground data, a ground data management system 31A that collects and manages sensor data output by a sensor device 33 via a network 32A, and a ground data management system 31B that collects and manages data (hereinafter, referred to as network data) independent of the sensor device 33 via a network 32B.

Hereinafter, the ground data management systems 31A and 31B will be referred to as a ground data management system 31 in a case where it is not particularly necessary to distinguish between the ground data management systems 31A and 31B. The ground data corresponds to all data obtained by observation on the ground except data obtained by observation with the satellite 21, and includes sensor data collected by the ground data management system 31A and network data collected by the ground data management system 31B. However, even when primary data is data obtained by observation with a satellite (meteorological satellite), such as meteorological data, secondary data generated by performing processing, determination processing, recognition processing, and the like on the data on the ground is included in the ground data. Specific examples of the sensor data and the network data will be described later.

The ground data management systems 31A and 31B are illustrated respectively one by one in FIG. 1 for simplicity, but the number of these systems is not limited to one. The number and type of sensor devices 33 collected and managed by the ground data management system 31A are not limited to one.

The satellite image processing system 1 further includes a data analysis apparatus 41 as a system that performs analysis by using the satellite images and the ground data in a cooperation manner. The data analysis apparatus 41 is connected to the satellite image management system 12 and a plurality of the ground data management systems 31 via a network 42.

The satellite travel management system 11 manages a plurality of the satellites 21 owned by a satellite operation company. Specifically, the satellite travel management system 11 determines an operation plan for each of the satellites 21 traveling around the earth in a low orbit or a medium orbit. In response to a request from a customer, the satellite travel management system 11 transmits an imaging instruction to a predetermined satellite 21 via the communication device 13 to cause a desired satellite 21 to perform imaging.

The satellite image management system 12 acquires and stores the satellite image transmitted from the satellite 21 via the communication device 13. The acquired satellite image is transmitted to the data analysis apparatus 41 via the network 42.

The communication device 13 communicates with a predetermined satellite 21 designated by the satellite travel management system 11 under the control of the satellite travel management system 11. For example, the communication device 13 transmits, to a predetermined satellite 21, an imaging instruction to image a predetermined place (area) on the ground at a predetermined time. Furthermore, the communication device 13 receives a satellite image transmitted from the satellite 21 in the sky, and transmits the satellite image to the satellite image management system 12 via the network 15.

The satellite 21 travels around the earth in a low orbit or a middle orbit, and images a predetermined place on the ground at a designated time on the basis of the imaging instruction transmitted from the communication device 13. The satellite 21 transmits, to the communication device 13, the satellite image obtained by imaging.

The satellite 21 may be an optical satellite, or may be a synthetic aperture radar (SAR) satellite. A function (performance) of the camera (imaging sensor) mounted on the satellite 21, for example, sensitivity/shutter speed, resolution, monochrome/color, a band (wavelength range), and the like vary depending on the application, size, and the like of the satellite 21. Examples of the satellite image output from the satellite 21 also includes an image formed by receiving visible light, an image formed by receiving infrared light other than the visible light, a radar image, and a radio wave image, and these images vary depending on the camera mounted on the satellite 21. The satellite travel management system 11 appropriately selects the satellite 21 that satisfies a necessary condition according to the customer's request and the observation purpose, and causes the satellite to capture an image.

The ground data management system 31A acquires sensor data from the sensor device 33 via the network 32A and stores the sensor data therein. The ground data management system 31A transmits, to the data analysis apparatus 41, the sensor data stored in the ground data management system 31A in response to a request from the data analysis apparatus 41 or periodically via the network 42.

The sensor device 33 includes, at least, a sensor unit that detects a predetermined physical quantity on the ground or a relative or absolute value on the ground and a communication unit that is connected to and communicates with the network 32A, the sensor device 33 transmitting the detected sensor data to the ground data management system 31A.

Examples of the sensor unit included in the sensor device 33 include, for example, an acceleration sensor, a gyro sensor, a magnetic sensor, an odor sensor, an atmospheric pressure sensor, a temperature sensor, a humidity sensor, a wind speed sensor, an optical sensor (RGB sensor, IR sensor, or the like), and a GPS sensor, which are used as an Internet of Things (IoT) sensor.

The sensor data transmitted from the sensor device 33 to the ground data management system 31A includes not only the data (primary data) acquired by the sensor unit but also secondary data generated by performing processing, determination processing, recognition processing, and the like on the acquired data. The secondary data may be generated by the ground data management system 31A instead of the sensor device 33.

Examples of the sensor data include data obtained by a sensor unit installed in a traffic infrastructure such as a traffic light and an electronic toll collection system (ETC), data obtained by a sensor unit mounted on a mobile apparatus such as an automobile, a train, an airplane, or a drone, data of position information obtained from a GPS sensor mounted on a smartphone, a tablet, an automobile, a beacon of a wireless LAN, or the like, data of weather information, data of weather forecast information, and population data collected for research, study, or the like by each institution.

The ground data management system 31B acquires network data flowing through the network 32B and stores the network data therein. The ground data management system 31B transmits, to the data analysis apparatus 41, the network data stored in the ground data management system 31B in response to a request from the data analysis apparatus 41 or periodically via the network 42.

The network data transmitted from the ground data management system 31B to the data analysis apparatus 41 via the network 42 includes not only the data (primary data) acquired from the network 32B but also secondary data generated by performing processing, determination processing, recognition processing, and the like on the acquired data.

Examples of the network data include data (SNS data) such as a posting history and a conversation history in an SNS application, and log data of a transaction on the Web, such as a purchase history in net shopping.

The data analysis apparatus 41 performs predetermined data analysis by using the satellite image acquired from the satellite image management system 12 and the ground data (sensor data or network data) acquired from the ground data management systems 31A and 31B.

For example, the data analysis apparatus 41 acquires a satellite image from the satellite image management system 12, acquires ground data corresponding to a condition for capturing a satellite image from the ground data management system 31, and analyzes the satellite image by using the ground data and the satellite image. At this time, the ground data is used as complementary data for complementing the analysis of the satellite image.

Furthermore, for example, the data analysis apparatus 41 acquires ground data from the ground data management system 31, acquires a satellite image corresponding to the ground data from the satellite image management system 12, and analyzes the ground data by using the ground data and the satellite image. At this time, the satellite image is used as complementary data for complementing the analysis of the ground data.

The data analysis apparatus 41 provides the analysis result to an end user of a data analysis service or transmits the analysis result to a device of the end user. A system of an intermediate service provider may further intervene between the data analysis apparatus 41 and the end user.

Each of the networks 15, 32A, 32B, and 42 may be a wired communication network, may be a wireless communication network, and may be configured by both the wired and wireless communication networks. A part or all of the networks 15, 32A, 32B, and 42 may form the same network, or the networks 15, 32A, 32B, and 42 may respectively form different networks. These networks may be, for example, a communication network or a communication path of any communication standard, such as the Internet, a public telephone network, a wide-area communication network for a wireless mobile body, such as a so-called 4G line or 5G line, a wide area network (WAN), a local area network (LAN), a wireless communication network that performs communication conforming to the Bluetooth (registered trademark) standard, a communication path for satellite communication or short-range wireless communication such as near field communication (NFC), a communication path for infrared communication, and a communication network of wired communication conforming to a standard such as high-definition multimedia interface (HDMI (registered trademark)) or universal serial bus (USB).

The satellite image processing system 1 of FIG. 1 may include a plurality of satellite control systems according to the same or different operating entities, or may include a plurality of ground data acquisition systems according to the same or different operating entities.

The satellite image processing system 1 may be the entire system owned by a predetermined operating entity, or may be a part of another entire system. At least some of the satellite control system, the ground data acquisition system, and the data analysis apparatus, which constitute the satellite image processing system 1, may be shared by a plurality of operating entities.

The satellite travel management system 11, the satellite image management system 12, the ground data management systems 31A and 31B, and the data analysis apparatus 41 may be integrated as one apparatus.

The satellite image and the ground data may be accumulated in each of the satellite image management system 12 and the ground data management system 31 and transmitted to the data analysis apparatus 41 as necessary, or may be appropriately transmitted to the data analysis apparatus 41 and accumulated in the data analysis apparatus 41.

### 2. Configuration Example of Satellite Control System

FIG. 2 is a block diagram illustrating a more detailed configuration example of a satellite control system which is a part related to a satellite of the satellite image processing system 1.

A satellite operation company owns a satellite management system 16 that manages a plurality of satellites 21 and a plurality of communication devices 13 that communicates with the satellites 21. Note that the satellite management system 16 and some of a plurality of the communication devices 13 may be devices owned by entities other than the satellite operation company. The satellite management system 16 and a plurality of the communication devices 13 are connected to each other via a predetermined network 15. The communication device 13 is disposed in the ground station 14. FIG. 2 illustrates an example in which the number of communication devices 13 is three, for example, communication devices 13A to 13C, but any number of communication devices 13 may be adopted.

The satellite management system 16 is a system configured by integrating the satellite travel management system 11 and satellite image management system 12 in FIG. 1.

The satellite management system 16 manages a plurality of the satellites 21 owned by the satellite operation company. Specifically, the satellite management system 16 acquires related information from information provision server 17 of at least one external organization as necessary, and determines an operation plan for a plurality of the satellites 21 owned by the satellite operation company. Then, in response to a request from a customer, the satellite management system 16 transmits an imaging an imaging instruction to a predetermined satellite 21 via the communication device 13 to cause the predetermined satellite 21 to perform imaging. Furthermore, the satellite management system 16 acquires, displays, and stores the satellite image transmitted from the satellite 21 via the communication device 13. The acquired satellite image is subjected to predetermined image processing as necessary, and provided (transmitted) to the data analysis apparatus 41 (FIG. 1). Furthermore, the acquired satellite image may be subjected to predetermined image processing, and then provided to the customer.

The information provision server 17 installed in the external organization supplies predetermined related information to the satellite management system 16 via a predetermined network, in response to a requirement from the satellite management system 16 or periodically. For example, the related information provided from the information provision server 17 is as follows. For example, orbit information of a satellite described in a two-line elements (TLE) format (hereinafter, referred to as TLE information) can be acquired as related information from North American Air and Space Defense Command (NORAD) as an external organization. Furthermore, for example, it is possible to acquire weather information such as weather and cloud cover at a predetermined point on the earth, from a weather information provision company as an external organization.

The communication device 13 communicates with a predetermined satellite 21 designated by the satellite management system 16 via an antenna under the control of the satellite management system 16. For example, the communication device 13 transmits, to the predetermined satellite 21, an imaging instruction to image a predetermined place (area) on the ground. Furthermore, the communication device 13 receives a satellite image transmitted from the satellite 21, and supplies the satellite image to the satellite management system 16 via the network 15. Transmission from the communication device 13 of the ground station 14 to the satellite 21 is also referred to as uplink transmission, and transmission from the satellite 21 to the communication device 13 is also referred to as downlink transmission. The communication device 13 can perform direct communication with the satellite 21, and can also perform communication via a relay satellite 22. As the relay satellite 22, for example, a geostationary satellite is used.

Single satellite 21 may be operated and a plurality of satellites 21 may be operated. A plurality of the operated satellites 21 constitutes a satellite group 23. In FIG. 2, a satellite 21A and a satellite 21B are respectively operated, and a satellite 21C and a satellite 21D constitute a satellite group 23A. Note that, in the example of FIG. 2, for the sake of simplicity, an example is illustrated in which one satellite group 23 includes two satellites 21, but the number of satellites 21 included in one satellite group 23 is not limited to two.

As a system that operates a plurality of satellites 21 as one unit (satellite group 23), there are a constellation system and a formation flight system. The constellation system is a system in which a large number of satellites 21 are provided to a single orbital plane or a plurality of orbital planes to uniformly deploy a service mainly around the entire sphere. Even a single satellite has a predetermined function, and a plurality of the satellites 21 is operated for the purpose of improving an observation frequency and the like. On the other hand, the formation flight system is a system in which a plurality of the satellites 21 is deployed in a narrow area of about several kilometers while maintaining a relative positional relationship. In the formation flight system, it is possible to provide services that cannot be realized by the single satellite, such as highly accurate three-dimensional measurement and speed detection for a moving object. In the present embodiment, the satellite group may be operated in the constellation system or the formation flight system.

In a case where the communication device 13 communicates with each satellite 21, there are provided a method of directly communicating with the satellites 21 such as the satellite 21A and the satellite 21B, and a method of indirectly communicating with the satellite 21D by performing inter-satellite communication with the satellite 21C which is another satellite 21. The method of indirect communication also includes communication via the relay satellite 22. Which method is to be used for communication with (the communication device 13 of) the ground station 14 may be determined in advance in accordance with the satellite 21, or may be appropriately selected in accordance with contents of communication.

In the satellite control system configured as described above, the satellite 21 as an observation satellite images a predetermined point on the ground on the basis of an imaging instruction from the satellite management system 16. The satellite image captured by the satellite 21 is accumulated in the satellite management system 16.

### 3. Configuration Example of Sensor Device

The sensor device 33 may be configured as a single device for acquiring sensor data or may be included as part of another main device.

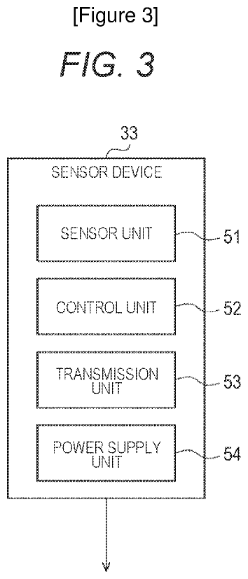

FIG. 3 is a block diagram illustrating a configuration example in a case where the sensor device 33 is configured as a single device.

The sensor device 33 includes a sensor unit 51, a control unit 52, a transmission unit 53, and a power supply unit 54.

The sensor unit 51 includes one or more types of predetermined sensors according to the purpose of detection. For example, the sensor unit 51 includes an odor sensor, an atmospheric pressure sensor, and a temperature sensor. Furthermore, for example, the sensor unit 51 may include an image sensor (an RGB sensor, an IR sensor, or the like). A plurality of sensors of the same type or different types may be mounted on the sensor unit 51.

The control unit 52 controls the entire operation of the sensor device 33. In a case where predetermined sensor data is detected by the sensor unit 51, the control unit 52 causes the transmission unit 53 to transmit the detected sensor data to the ground data management system 31A. The detected sensor data may be accumulated therein for a certain period of time and then transmitted to the ground data management system 31A. The transmission unit 53 transmits the sensor data to the ground data management system 31A via the network 32A under the control of the control unit 52.

The communication performed by the transmission unit 53 may be satellite communication. In a case where the sensor device 33 is installed in a place where an infrastructure network of a network is not provided, such as a mountain area, an ocean area, or a desert area, the sensor device 33 directs an antenna (not illustrated) to the satellite 21 passing nearby, and transmits the sensor data to the satellite 21 serving as a target.

The power supply unit 54 includes, for example, a battery or the like charged by solar power generation or the like, and supplies power to each unit of the sensor device 33.

The sensor device 33 is configured as described above, and transmits the acquired sensor data to the ground data management system 31A.

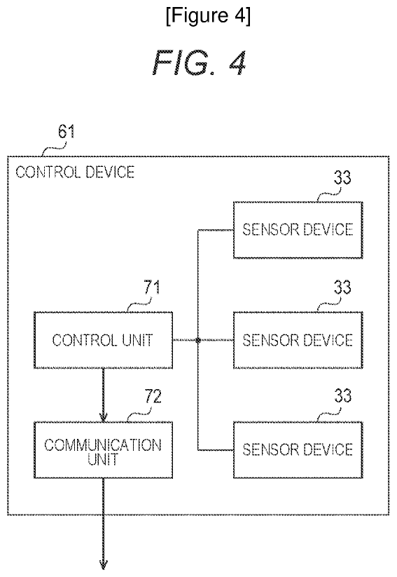

FIG. 4 is a block diagram illustrating a configuration example in a case where the sensor device 33 is configured as a part of a main device. In FIG. 4, the sensor device 33 is configured as a part of a control device 61.

The control device 61 includes, at least, a control unit 71, a communication unit 72, and one or more sensor devices 33. In FIG. 4, three sensor devices 33 are mounted on the control device 61, but the number of sensor devices 33 is arbitrary. A plurality of sensor devices 33 may include the same sensor devices or may be sensor devices capable of acquiring different sensor data.

The control unit 71 acquires sensor data detected by a plurality of the sensor devices 33, and causes the communication unit 72 to transmit the acquired sensor data.

The communication unit 72 transmits the sensor data to the ground data management system 31A under the control of the control unit 71.

The control device 61 corresponds to, for example, a smartphone or personal computer owned by an individual, a traffic light installed on a road or the like, a monitoring camera, a weather camera, a parking monitoring device installed in a parking lot, an ETC gate installed on an expressway, or the like.

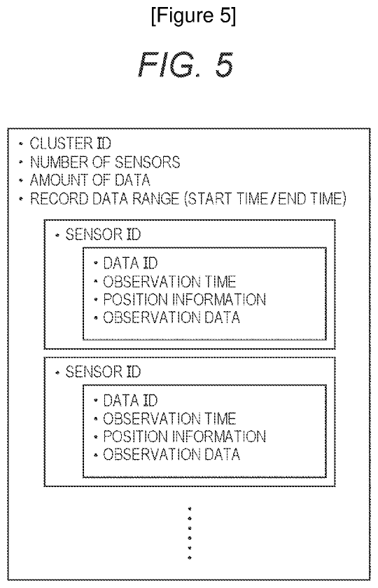

FIG. 5 illustrates an example of a data format in a case where the sensor device 33 or the control device 61 includes a plurality of sensors, the data being sensor data output by the sensor device 33 or the control device 61.

In a case where the sensor device 33 or the control device 61 includes a plurality of sensors, the sensor data is output as one cluster data configured by collecting the sensor data of each of a plurality of sensors.

The cluster data includes Cluster ID, Number of sensors, Amount of data, and Record data range.

Cluster ID is cluster identification information for uniquely identifying cluster data.

Number of sensors indicates the number of sensors, which is included in the cluster data.

Amount of data indicates the total amount of sensor data, which is included in the cluster data.

A data collection start time and data collection end time for the sensor data included in the cluster data are stored in Record data range.

Following Record data range, sensor data including Sensor ID, Data ID, Observation time, Position information, and Observation data is stored for each of a plurality of the sensors.

Sensor ID is sensor identification information for uniquely identifying the sensor.

Data ID is data identification information for identifying the type of sensor data.

Observation time indicates a time at which sensor data is observed.

Position information indicates a position at which sensor data is observed.

Observation data indicates a value acquired by the sensor.

In a case where the sensor device 33 or the control device 61 includes a plurality of sensors, the control unit 52 or the control unit 71 generates cluster data configured by collecting the sensor data of each sensor, and outputs the cluster data.

In a case where the sensor device 33 or the control device 61 includes only one sensor, sensor data including Sensor ID, Data ID, Observation time, Position information, and Observation data, which are described above, is output.

Furthermore, for example, in a case where a large number of sensor devices 33 are installed on a farm site, the ground data management system 31 may include a data collection function for collecting sensor data, and generate cluster data from the collected sensor data. Alternatively, one given sensor device 33 of a large number of sensor devices 33 may include a data collection function, and collect sensor data of other sensor devices 33 to generate cluster data.

<4. Collection Method For Ground Data and Satellite Images>

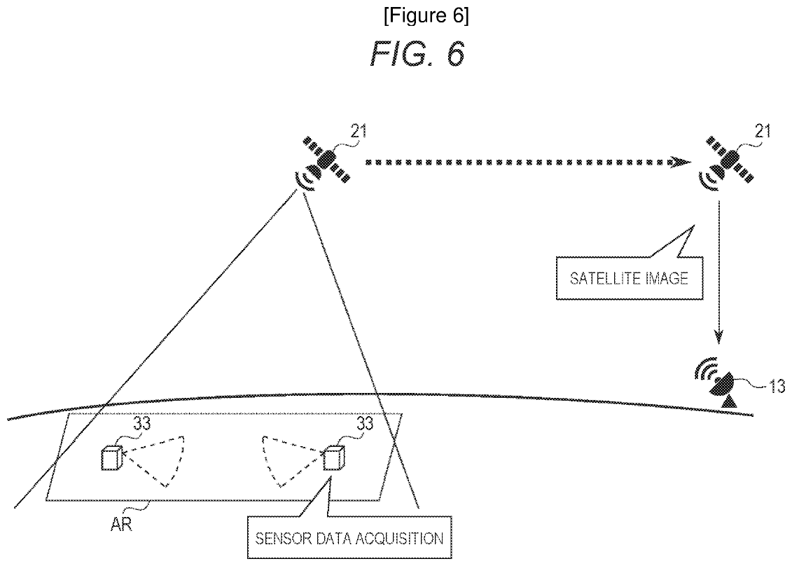

FIG. 6 is a diagram illustrating an example of a representative collection method for ground data and satellite images.

In the example of FIG. 6, a predetermined area AR on the ground is a place to be analyzed, and the area AR is, for example, an agricultural land.

The sensor device 33 installed in the area AR detects the temperature or the like in the agricultural land, monitors the growth state of agricultural products, and collects micro sample data. Sensor data detected by the sensor device 33 is transmitted to the ground data management system 31A via the network 32A.

When passing over the area AR, the satellite 21 images the area AR and generates and stores a satellite image including the area AR. When passing over the communication device 13 of the ground station 14, the satellite 21 transmits (downlinks) the stored satellite image to the communication device 13.

As described above, in general, the sensor data is accumulated in the ground data management system 31 via the communication line on the ground, and the satellite image is accumulated in the satellite image management system 12 via the communication device 13 of the ground station 14.

On the other hand, the sensor device 33 may be placed in an area that is not connected to the communication line on the ground, such as an ocean area or a mountainous area. In such cases, the sensor data is collected through a store-and-forward scheme.

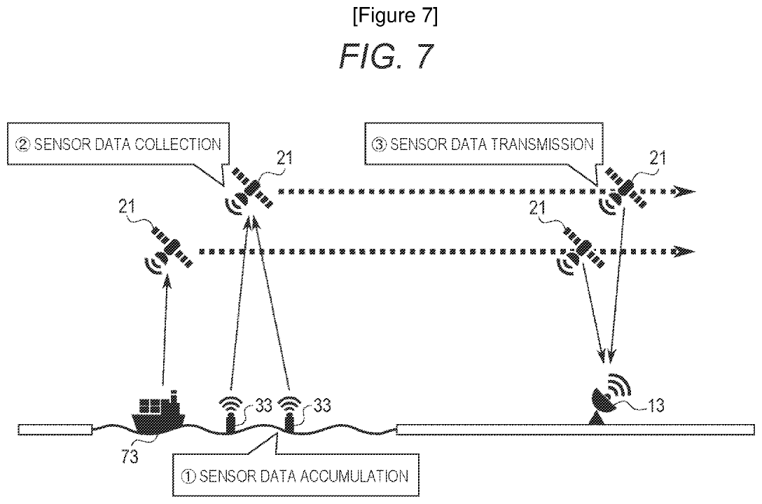

FIG. 7 is a diagram for explaining collection of sensor data through the store-and-forward scheme.

The sensor device 33 (not illustrated) installed in a ship 73 in the ocean or the sensor device 33 installed in a buoy or the like acquires sensor data at a predetermined timing and accumulates the sensor data therein.

The sensor device 33 transmits the accumulated sensor data to the satellite 21 at a timing when the satellite 21 passes over the sensor device 33. The satellite 21 collects sensor data transmitted from the sensor devices 33.

After that, when passing over the communication device 13 of the ground station 14, the satellite 21 transmits the stored sensor data to the communication device 13. The sensor data collected through the store-and-forward scheme is transmitted to the ground data management system 31 via the satellite image management system 12 or the like.

### 5. Configuration Example of Data Analysis Apparatus

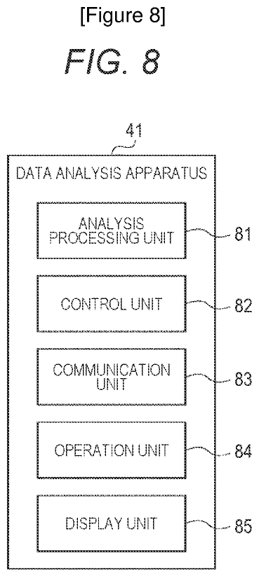

FIG. 8 is a block diagram illustrating a configuration example of the data analysis apparatus 41.

The data analysis apparatus 41 includes an analysis processing unit 81, a control unit 82, a communication unit 83, an operation unit 84, and a display unit 85.

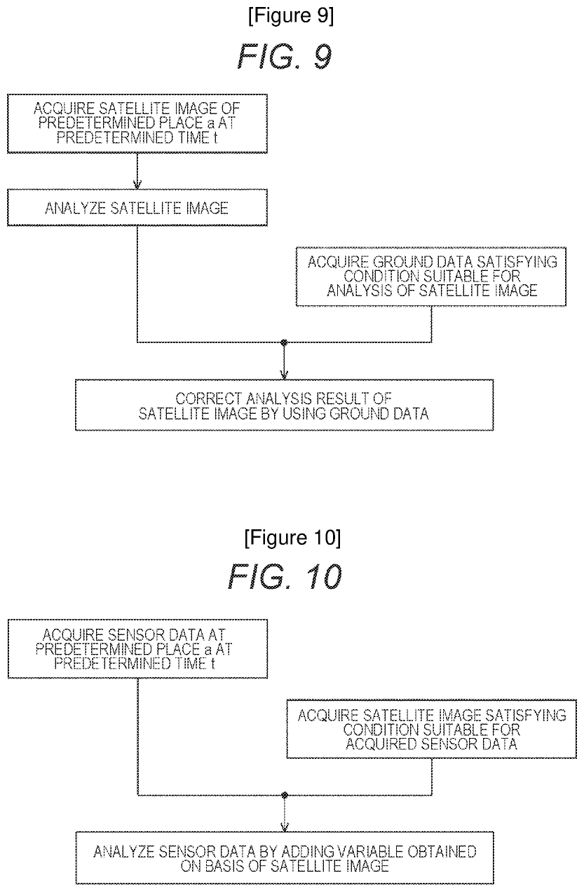

The analysis processing unit 81 performs predetermined data analysis by using the satellite image acquired from the satellite image management system 12 and the ground data acquired from the ground data management system 31. An example of the analysis processing performed by the analysis processing unit 81 will be described later with reference to FIG. 9 and subsequent drawings.

The control unit 82 controls the entire operation of the data analysis apparatus 41 by executing an analysis application program stored in a storage unit (not illustrated).

Under the control of the control unit 82, the communication unit 83 performs predetermined communication with the satellite image management system 12, the ground data management system 31, or the terminal device of the end user. The communication unit 83 has a role as a data acquisition unit that acquires a satellite image from the satellite image management system 12 and acquires ground data from the ground data management system 31.

The operation unit 84 includes, for example, a keyboard, a mouse, a touch panel, or the like, receives a command or data input based on a user (operator) operation, and supplies the command or the data to the control unit 82.

The display unit 85 includes, for example, an LCD or an organic EL display, and displays an analysis result obtained by the analysis processing unit 81 or displays the satellite image, the ground data, or the like.

FIG. 9 is a diagram illustrating an outline of first data analysis processing using the satellite image and the ground data, the first data analysis processing being executed by the analysis processing unit 81.

The analysis processing unit 81 acquires a satellite image obtained by imaging a predetermined place a at a predetermined time t from the satellite image management system 12, and analyzes the acquired satellite image.

For example, in the case of analysis for agricultural use, satellite images, which are obtained by imaging a farm with a satellite 21 equipped with multi-spectrum cameras for different bands such as red (R) and infrared (IR), are acquired. In the imaging for agricultural use, for example, imaging is performed at the same time every time the incident angle of the sun light is the same. The analysis processing unit 81 analyzes a vegetation index such as a normalized difference vegetation index (NDVI) and a crop growth state by analyzing the acquired satellite image.

On the other hand, the analysis processing unit 81 acquires ground data satisfying a condition suitable for analyzing the satellite image from the ground data accumulated in the ground data management system 31. For example, sensor data detected by the sensor device 33 installed on a farm at a predetermined place a is acquired as ground data.

The analysis processing unit 81 corrects the analysis result of the satellite image by using the acquired ground data.

For example, the analysis processing unit 81 corrects the NDVI data of the entire farm analyzed on the basis of the satellite image and actual NDVI sample measurement data acquired by the sensor device 33.

Furthermore, for example, the analysis processing unit 81 corrects the NDVI data of the entire farm analyzed on the basis of the satellite image, and the sensor data obtained by detecting a soil component and the sensor data obtained by detecting the occurrence state of pests, which are acquired by the sensor devices 33.

For example, the analysis processing unit 81 creates a photosynthesis model based on the kinds of plants from the sensor data acquired by the sensor device 33, and corrects the photosynthesis model analyzed on the basis of the satellite image.

As described above, according to the first data analysis processing, since the ground data is used as complementary data for the analysis result based on the satellite image, the analysis accuracy of the satellite image can be increased.

FIG. 10 is a diagram illustrating an outline of second data analysis processing using the satellite image and the ground data, the second data analysis processing being executed by the analysis processing unit 81.

The analysis processing unit 81 acquires sensor data detected at a predetermined time t in the sensor device 33 installed at a predetermined place a. For example, sensor data of the sensor device 33 which is installed in a ship or a buoy on the sea and detects a seawater temperature, a fish group, a growth state of marine products, and the like is acquired.

Furthermore, the analysis processing unit 81 acquires a satellite image satisfying a condition suitable for the acquired sensor data from the satellite image management system 12. For example, the analysis processing unit 81 acquires a satellite image obtained by imaging a wide sea area including a place at which the sensor data of the sensor device 33 is acquired.

The analysis processing unit 81 analyzes the sensor data by adding a variable obtained on the basis of the acquired satellite image.

For example, the analysis result for the sensor data is corrected by further adding a macro variable obtained from the satellite image, for example, situations such as a shadow due to a cloud, occurrence of a fish group, distribution of seawater temperature in a wide area, occurrence of a red tide, and the like, to the seawater temperature, the fish group, and the growth state of the marine products, which are analyzed from the sensor data of the sensor device 33.

As described above, according to the second data analysis processing, since the analysis data of the satellite image (satellite image data) is used as complementary data in analysis with the ground data, the analysis accuracy of the ground data can be increased. The data obtained from the satellite image is used as the complementary data, thus it is possible to analyze the ground data in consideration of events in a wide area. In a case where the sensor device 33 is specifically an IoT sensor, there is a case where the sensor device 33 has only simple performance instead of being designed to be low cost and long-lasting, and there is a case where only the data obtained from the sensor device 33 includes little information, and thus the result cannot be analyzed. In such a case, the analysis data of the satellite image (satellite image data) is used as the complementary data, and thus the analysis accuracy of the ground data can be increased.

<6. Acquisition Timing of Ground Data and Acquisition Timing of Satellite Image>

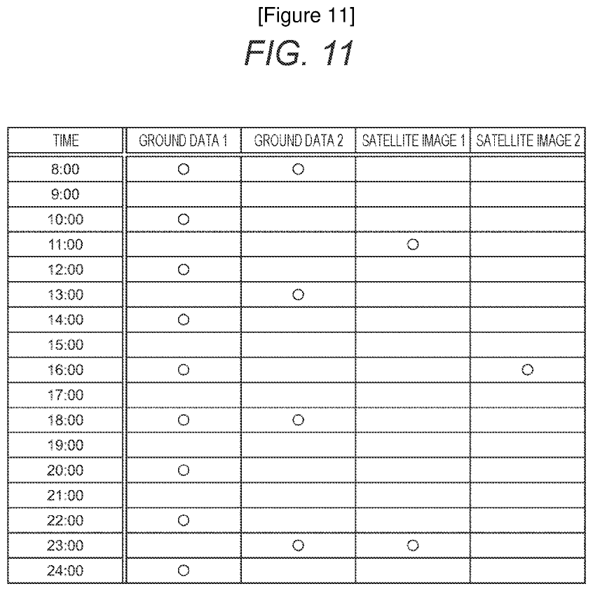

FIG. 11 is a diagram illustrating an example of an acquisition timing of ground data and an acquisition timing of a satellite image.

The sensor device 33 may prioritize durability and have only simple performance, and the data obtained from the sensor device 33 may be intermittent and local data. Even in a case where the ground data is network data that does not depend on the sensor device 33, it is not always possible to acquire the ground data, and thus there is a case where the ground data is intermittently acquired.

In the example of FIG. 11, first ground data (ground data 1) is acquired every two hours, for example, 8:00, 10:00, 12:00, 14:00, ••••, and second ground data (ground data 2) is acquired every five hours, for example, 8:00, 13:00, 18:00, 23:00, ••••.

Since the satellite 21 travels around the earth and returns to the same point over a predetermined period of times or days, in a case where the satellite image is limited to a specific place, the satellite image can also be obtained only for a specific time. For example, a low orbit satellite having a one-day prograde orbit can capture an image from the same sky position only once a day. Even in a case where a plurality of the satellites 21 operated in the constellation system is used, the number of times of imaging of a specific point in one day is only about several times to several tens of times.

In the example of FIG. 11, the first satellite image (satellite image 1) can be acquired only twice a day at 11:00 and 23:00. The second satellite image (satellite image 2) can be acquired only once a day at 16:00.

Therefore, in the first data analysis processing described in FIG. 9, in a case where the data analysis apparatus 41 corrects the analysis result of the satellite image obtained by imaging a predetermined place a at a predetermined time t by using the ground data as complementary data, the probability that the ground data corresponding to the same time and the same place exists is low. In such a case, a problem is that what kind of data should be acquired and used for data analysis as ground data corresponding to the satellite image obtained by imaging a predetermined place a at a predetermined time t.

Furthermore, in the second data analysis processing described in FIG. 10, in a case where the data analysis apparatus 41 acquires sensor data of the sensor device 33 installed at a predetermined place a and at a predetermined time t, and acquires a satellite image suitable for analysis of the acquired sensor data, the probability that the satellite 21 which passes over a desired place a at a desired time t and performs imaging is low. In such a case, a problem is that what kind of satellite image should be acquired and used for data analysis as a satellite image corresponding to the ground data obtained by imaging a predetermined place a at a predetermined time t.

Hereinafter, a preferred method for selecting the ground data or the satellite image to be used as the complementary data in the first and second data analysis processing using the ground data and the satellite image will be described.

### 7. Example of First Analysis Processing Using Ground Data as Complementary Data

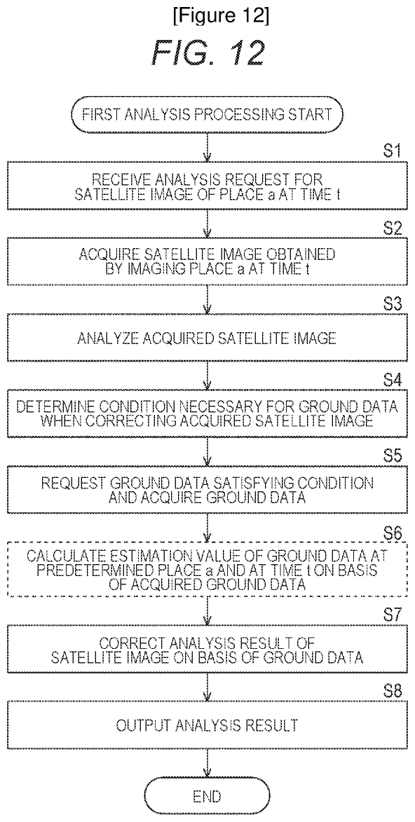

An example of the first analysis processing using ground data as complementary data in analysis processing for a satellite image will be described with reference to a flowchart of FIG. 12. For example, this processing is started when an analysis request for the satellite image of a predetermined place a at a time t is transmitted from (the terminal device of) the end user of the data analysis service.

First, in step S1, the analysis processing unit 81 of the data analysis apparatus 41 receives an analysis request for the satellite image of the place a at the time t from (the terminal device of) the end user of the data analysis service.

The analysis processing unit 81 acquires a satellite image obtained by imaging the place a at the time t from the satellite image management system 12 in step S2, and analyzes the acquired satellite image in step S3. For example, as described above, the predetermined place a is a farm, and the analysis processing unit 81 analyzes the vegetation index of the place a and the growth state of the crop.

In step S4, the analysis processing unit 81 determines a condition necessary for the ground data when correcting the acquired satellite image.

For example, the analysis processing unit 81 can determine that the condition necessary for the ground data is a time close to an imaging time t of the satellite image. The time close to the imaging time t of the satellite image may be a time close to the imaging time t in an absolute time and a time relatively close to the imaging time t. In a case where a time close to the imaging time t in the absolute time is set as a condition, for example, the ground data detected at a time t±x (x is a positive integer) within a predetermined range from the imaging time t of the satellite image is set as a condition of the acquired ground data. In this case, even when the ground data is not the ground data at the same time, the ground data can be analyzed as data in the same time zone. On the other hand, in a case where the relatively close time is set as a condition, a time closer to the imaging time t of the satellite image among a plurality of candidates for the ground data is set as a condition of the acquired ground data.

Furthermore, for example, the analysis processing unit 81 can determine that the condition necessary for the ground data is a place close to a place a of the satellite image. Specifically, in a case where the sensor device 33 is not installed in an imaging area A of the satellite image obtained by imaging the place a, ground data detected by the sensor device 33 installed in an area close to the imaging area A is set as a condition of the acquired ground data. For example, in a case where sensor data is acquired from a ship performing marine observation, and in a case where the ship does not exist in a target sea area (imaging area A) captured in a satellite image, analysis can be performed using the sensor data detected by the ship in a sea area close to the target sea area.

Furthermore, for example, the analysis processing unit 81 can determine that the condition necessary for the ground data is a close environmental condition. Specifically, the ground data detected by the sensor device 33 in an environment similar to an environment such as a time t and a place a at which the satellite image is acquired is set as a condition of the acquired ground data. When the environmental condition is a weather condition, the ground data detected in a temperature and weather which are the closest to the temperature and weather at the time t and at the place a is set as a condition of the acquired ground data. Furthermore, when the environmental condition is the incident angle of the sun light, the ground data acquired at an incident angle similar to or the closest to the incident angle at the time t and at the place a is set as a condition of the acquired ground data. In the vegetation index for agriculture and the like, since the characteristics change depending on the incident conditions of the sun light, it is important that the incident angles are the same.

When determining a condition necessary as ground data to be acquired, the analysis processing unit 81 requests the ground data management system 31 to transmit ground data satisfying the condition and acquires the ground data in step S5. The ground data management system 31 acquires the requested ground data from the accumulated data, and transmits the acquired ground data to the data analysis apparatus 41. In a case where the data analysis apparatus 41 acquires ground data in advance and stores the ground data, the ground data is acquired from its own storage unit.

In a case where the condition of the acquired ground data is set as the close time, data are collated and retrieved on the basis of imaging time information stored as metadata of a satellite image in a format such as Geo TIFF and an observation time (FIG. 5) of the sensor data.

In a case where the condition of the acquired ground data is set as the close place, data is collated and retrieved on the basis of estimated position information stored as metadata of a satellite image in a format such as Geo TIFF and a position information (FIG. 5) of the sensor data. Both the data may be collated on the basis of a distance from a landmark (reference point) instead of the absolute position coordinates. At this time, the calibration of the estimated position information stored as the metadata of the satellite image may also be performed on the basis of the landmark.

In a case where the condition of the acquired ground data is set as a close environmental condition, the weather condition or the incident angle condition at the time t and the place a at which the satellite image is captured is acquired or calculated, and sensor data close thereto is retrieved.

The ground data acquired as data suitable for correction of the satellite image is stored in the inside (storage unit) of the data analysis apparatus 41 by using the ground data and the satellite image in association with each other, for example, by associating a satellite ID for identifying the satellite image.

Since the processing of the next step S6 is processing executed as necessary and may be omitted, steps S7 and S8 will be described first.

In step S7, the analysis processing unit 81 corrects the analysis result of the satellite image on the basis of the acquired ground data. For example, the analysis processing unit 81 corrects an image indicating NDVI information, estimated temperature information, and the like as an analysis result on the basis of the acquired sensor data. Information based on the acquired sensor data may be superimposed and displayed on the satellite image as the analysis result. The weighting of the correction degree may be changed according to the degree of coincidence of the conditions of the acquired ground data, for example, the temporal closeness or the place closeness.

In step S8, the analysis processing unit 81 outputs the corrected analysis result to its own display unit 85, the terminal device of the end user, or the like, and ends the first analysis processing.

Processing in step S6 will be described.

The basic first analysis processing omitted in step S6 is processing of requesting the ground data satisfying the condition to the ground data management system 31 and correcting the analysis result of the satellite image by using the acquired ground data as it is.

On the other hand, since the acquired ground data does not completely satisfy the conditions such as a predetermined place a and a time t, the first analysis processing in a case where step S6 is performed is processing of calculating an estimation value of the ground data at a predetermined place a and at a time t, and correcting the analysis result of the satellite image by using the calculated estimation value of the ground data.

In step S6, processing of calculating the estimation value of the ground data at the predetermined place a and at the time t which are the same as those of the satellite image is performed on the basis of the acquired ground data.

For example, in a case where the ground data acquired in step S5 is not the ground data at the time t, the analysis processing unit 81 calculates an estimation value of the ground data at the time t from the ground data at times t1, t2, acquired in step S5 (t≠t1, t2, •••). The ground data from which the estimation value of the ground data at the time t can be easily calculated may be acquired in step S5 described above.

Furthermore, for example, in a case where the ground data acquired in step S5 is not the place a, the analysis processing unit 81 calculates an estimation value of the ground data at the place a from the ground data at places a1, a2, ••• acquired in step S5 (a≠a1, a2, •••). The ground data from which the estimation value of the ground data at the place a can be easily calculated may be acquired in step S5 described above. In a case where the ground data is data acquired by the sensor device 33 installed on a moving object such as a ship or an animal, an estimation value of the ground data at the time t may be calculated.

In a case where the environmental condition of the ground data acquired in step S5 is different, the analysis processing unit 81 calculates an estimation value of the ground data under a desired environmental condition. For example, in a case where the acquired sensor data is a temperature one hour before the satellite image capturing, the estimation value of the temperature one hour after the satellite image capturing is calculated. The ground data from which the estimation value of the ground data in a desired environmental condition can be easily calculated may be acquired in step S5 described above.

In step S7 in a case where the processing in step S6 is executed, the analysis processing unit 81 corrects the analysis result of the satellite image on the basis of the estimation value of the ground data calculated in step S6. Then, in step S8, the analysis result is output, and the first analysis processing ends.

In step S5 described above, in a case where there is a plurality of pieces of ground data satisfying the condition, the analysis processing unit 81 may acquire the most reliable ground data as representative data and use the acquired ground data as complementary data. Alternatively, an average value or a median value of a plurality of pieces of ground data satisfying the condition may be calculated and used as the complementary data. Alternatively, the estimation values at the representative point, the average point, and the intermediate point in spatial distribution of a plurality of pieces of ground data satisfying the condition may be calculated and used as the complementary data.

The processing of step S3 and the processing of steps S4 to S6 of the first analysis processing described above may be executed in reverse order, or may be executed in parallel.

### 8. Application Example of First Analysis Processing

Next, as an application example of the first analysis processing, the first analysis processing using two-stage imaging of the satellite 21 will be described.

The two-stage imaging is a method in which analysis processing mainly focusing on change extraction is first performed using a satellite image captured by a first satellite 21, and in a case where a change is found, detailed imaging is performed by a second satellite 21 having necessary performance. The first satellite image from first satellite 21 is used to determine whether or not the second satellite 21 needs to perform imaging.

Since the first satellite 21 in the two-stage imaging is a satellite for detecting change extraction as an event and only needs to be capable of extracting a change, the camera mounted on the first satellite 21 may have a lower resolution than that of the second satellite 21. However, it is desirable that the first satellite 21 can image a wider area as compared with the second satellite 21. The camera mounted on the first satellite 21 may be a camera that is specialized for recognition use and outputs an image invisible to humans.

For example, an AI engine using machine learning or the like may be used to extract the change. Even when a human cannot confirm the change visually, it is sufficient that some change can be estimated by the analysis processing unit 81 and details thereof may not be understood at this stage. The change can be extracted, for example, as a difference between the satellite images at the time of the previous imaging.

The second satellite 21 is a satellite having performance necessary for confirming details of the change, and a satellite is used which has a function (performance) necessary for analyzing (observing) details such as reserving power (resolution), monochrome/color, and a band (wavelength range). For example, in a case where it is necessary to recognize the satellite image as an image, the second satellite 21 is a satellite including a high-resolution camera as compared with the first satellite 21. For example, in a case where it is necessary to create an index such as NDVI for analysis of the satellite image, the second satellite 21 is a satellite including multi-spectrum cameras for different bands such as red (R) and infrared (IR). For example, in a case where it is necessary to obtain altitude information, the second satellite 21 is regarded as a SAR satellite.

Imaging by the second satellite 21 may be performed several hours or several days after the imaging time of the first imaging 21. The imaging plan of the second satellite 21 can be determined according to the analysis result obtained by using the satellite image from the first satellite 21 and the ground data.

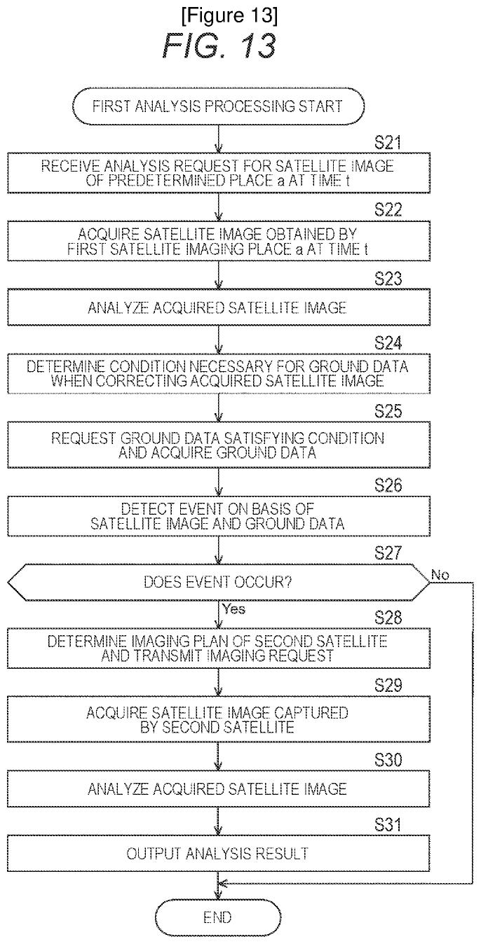

FIG. 13 is a flowchart illustrating the first analysis processing using two-stage imaging, which is an application example of the first analysis processing in FIG. 12. For example, this processing is started when an analysis request for the satellite image of a predetermined place a at a time t is transmitted from (the terminal device of) the end user of the data analysis service.

First, in step S21, the analysis processing unit 81 of the data analysis apparatus 41 receives an analysis request for the satellite image of a predetermined place a at a time t from (the terminal device of) the end user of the data analysis service.

The analysis processing unit 81 acquires, from the satellite image management system 12, a satellite image from the first satellite 21, the satellite image being obtained by imaging a predetermined place a at a time t in step S22, and analyzes the acquired satellite image in step S23.

In step S24, the analysis processing unit 81 determines a condition necessary for the ground data when correcting the acquired satellite image.

In step S25, the analysis processing unit 81 requests the ground data management system 31 to transmit ground data satisfying the condition and acquires the ground data.

In step S26, the analysis processing unit 81 detects an event on the basis of the acquired satellite image and the acquired ground data.

The processing in steps S21 to S26 are basically similar to the processing in steps S1 to S5 and step S7 in FIG. 12. However, the first satellite 21 in the two-stage imaging is a satellite for detecting extraction of a change as an event, and it is sufficient to be capable of estimating that there is some change by using the captured satellite image. The ground data is used to increase the accuracy of change extraction. For example, in a case where it is detected whether or not a red tide occurs as an event, sensor data of the sensor device 33 installed in the ship or buoy is acquired, and occurrence of the event is determined using the sensor data as complementary data. For example, in a case where it is detected whether or not a traffic jam occurs as an event, vehicle data acquired by the sensor device 33 of a traffic light or a vehicle is used as complementary data, and occurrence of the event is determined.

In step S27, the analysis processing unit 81 determines whether the event occurs as a result of the event detection in step S26.

In step S27, in a case where it is determined that the event does not occur, the first analysis processing ends.

On the other hand, in step S27, in a case where it is determined that the event occurs, the processing of steps S28 to S31 are executed.

In step S28, the analysis processing unit 81 determines an imaging plan of the second satellite 21, and transmits an imaging request based on the imaging plan to the satellite travel management system 11. As the second satellite 21, a satellite having performance necessary for confirming details of a change is determined, and an imaging time and a place (satellite position) are determined. Imaging by the second imaging is planned several hours to several days after the imaging by the first imaging 21.

In step S29, the analysis processing unit 81 acquires a satellite image captured by the second satellite 21 from the satellite image management system 12. The satellite image captured by the second satellite 21 is, for example, an image obtained by imaging a place a at a time t, the place a and time t being the same as those of the first satellite 21, but is different in imaging range, resolution, wavelength, and the like.

In step S30, the analysis processing unit 81 analyzes the satellite image captured by the second satellite 21, and confirms the details of the change. In the analysis of the satellite image, analysis may be performed using only the satellite image captured by the second satellite 21, or analysis may be performed using the ground data obtained when the occurrence of the event is determined in the first satellite 21 as complementary data. Alternatively, furthermore, ground data corresponding to the imaging timing of the second satellite 21 may be requested, and the analysis may be performed using the acquired ground data as complementary data.

In step S31, the analysis processing unit 81 outputs the analysis result and ends the first analysis processing in FIG. 13.

### 9. Specific Example of First Analysis Processing

A specific example of the first analysis processing will be described.
Agriculture

When a satellite image is analyzed, the satellite image being captured by a satellite 21 including multi-spectrum cameras for different bands such as R and IR, a photosynthesis state of a plant is estimated, and a vegetation index such as NDVI is calculated. For example, it is analyzed whether or not there is unevenness in a growth state in a cultivated field, whether or not there is occurrence of pests, how to manage the timing and amount of watering and the timing and amount of fertilizer application, and how much harvest can be expected.

However, since the state on the ground is not known only with the analysis using the satellite image, there may be an error in an estimation model. By using the state obtained from the sensor data of the sensor device 33 installed on the ground, for example, the sample of the actual growth state of the plant or the sample of the soil state, the temperature, the plant growth state model, the sunlight amount, and the like, it is possible to increase the accuracy of estimation of the vegetation index based on the satellite image.
Ocean

When the satellite image captured by the satellite 21 including a camera using a band in an infrared region is analyzed, a temperature state of the ocean is obtained and a fish group and a growth state of marine products are estimated on the basis of the temperature state of the ocean.

By using the sensor data obtained by the sensor device 33 installed in the marine buoy or the ship, it is possible to further obtain the state in the sea and more accurately estimate the state. For example, estimation accuracy can be increased by estimating a wave height state in the ocean with the SAR satellite and adding the sensor data obtained by the sensor device 33 installed in the marine buoy or the ship as sample data.
Ship Monitoring

When a satellite image is analyzed, it is expected to monitor the navigation situation of a ship, such as finding a pirate or a suspicious ship. By using automatic identification system (AIS) information indicating the position of the ship and by using monitoring data obtained by the sensor device 33 installed on the coast or the marine buoy, for example, it is possible to distinguish between a known ship and an unknown ship and increase the monitoring accuracy.
Resource Exploration

When the satellite images from the satellite 21 including a multi-spectrum camera and the satellite 21 (SAR satellite) including a synthetic aperture radar is analyzed, the resource exploration is performed. When ground data such as earthquake data and water quality data are used as sensor data, the accuracy of exploration can be further improved.
City Planning/City Situation

When the satellite images from the satellite 21 including a high-resolution visible-light camera or synthetic aperture radar is analyzed, the city situation monitoring is performed. For example, land evaluation to assess the strength of cultivated land is against disasters, and confirmation of changes in cities such as changes in roads and new buildings are performed.

When the ground data is used in addition to the satellite image, the monitoring accuracy can be increased. For example, the estimation accuracy for the appearance of a road, a construction site, or a new building can be increased when a change in travel state of the vehicle group, position information of SNS, population data, and the like are used.
Economic Indicator

When the satellite images from the satellite 21 including a high-resolution visible-light camera or synthetic aperture radar is analyzed, observation for an economic indicator estimation is performed. For example, a traffic volume and the number of cars at a store are obtained, a resource loading state in a harbor is obtained, and a state of a storage base of resources such as oil is obtained.

When analysis is performed using the ground data obtained from a monitoring camera of a ship or a monitoring camera in the city or other sensors, for example, detailed data of a specific point can be sampled, and the accuracy of estimation based on the satellite image can be increased.

As described above, according to the first data analysis processing of analyzing the satellite image by using the ground data as complementary data, it is possible to select the ground data suitable for analysis of the satellite image and to increase the analysis accuracy for the satellite image.

### 10. Example of Second Analysis Processing using Satellite Image Data as Complementary Data

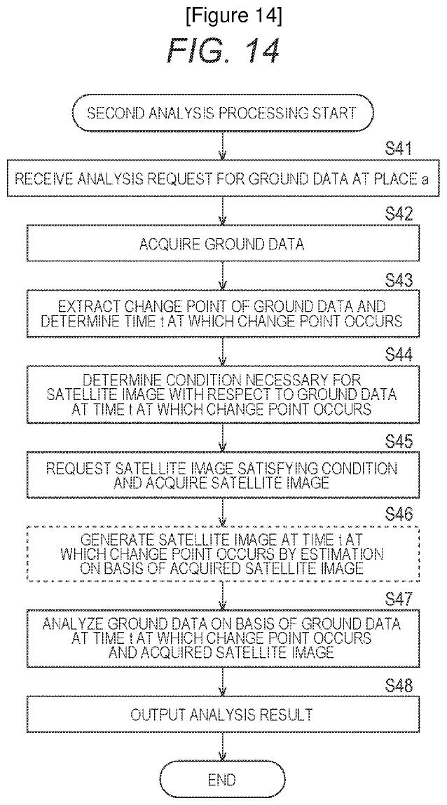

Next, an example of the second analysis processing using the satellite image data as complementary data in analysis processing on the ground data will be described with reference to a flowchart of FIG. 14. For example, this processing is started when an analysis request for the ground data at a predetermined place a is transmitted from (the terminal device of) the end user of the data analysis service.

First, in step S41, the analysis processing unit 81 of the data analysis apparatus 41 receives an analysis request for the ground data at the place a from (the terminal device of) the end user of the data analysis service. The analysis request is, for example, for analyzing a state of the ground data in the past predetermined period (for example, hours, one day, days, months, and the like) at the place a.

In step S42, the analysis processing unit 81 acquires, from the ground data management system 31, the ground data in the past predetermined period specified by the analysis request.

In step S43, the analysis processing unit 81 analyzes the acquired ground data at a predetermined period. For example, the analysis processing unit 81 extracts a time point at which a great change occurs in the acquired ground data at a predetermined period, a time point at which the ground data reaches a certain value, or the like as a change point, and determines a time t at which the change point occurs. The time t at which the change point occurs may be a specific time indicating one time point of discrete data, or may be a period (time zone) having a certain width.

In step S44, the analysis processing unit 81 determines a condition necessary for the satellite image with respect to the ground data at the time t at which the change point occurs.

For example, when the condition necessary for the satellite image is a close time, in the case of the close time in the absolute time, a satellite image captured at a time t±x (x is a positive integer) within a predetermined range from the time t of the ground data at which the change point occurs is set as a condition necessary for the satellite image. In a case where the time t is not a specific time but a period with a predetermined width, it is preferable that the imaging time of the satellite image is included in this period. Furthermore, in the case of a close time in the relative time, a time closer to the time t of the ground data at which the change point occurs is set as a condition necessary for the satellite image among a plurality of satellite images.

Furthermore, for example, when a condition necessary for the satellite image is a close place, a condition necessary for the satellite image is desirably that the place a is included in the imaging area A of the satellite image. In a case where the place a is not included in the imaging area A, for example, a satellite image having an imaging area close to the place a is set as a condition necessary for the satellite image. In a case where there is no satellite image including the place a, other conditions may be prioritized. For example, in a case where the ground data is data obtained by detecting a growth state of a plant, a condition may be a satellite image obtained by imaging a neighborhood agricultural land other than a satellite image of an urban area close to the place a. In a case where the ground data is sensor data obtained by the sensor device 33 installed in the ship, a condition may be a satellite image obtained by imaging a sea area other than a satellite image obtained by imaging a land close to the place a.

Furthermore, for example, when a condition necessary for the satellite image is a close environmental condition, a satellite image captured in an environment similar to the environment of the place a at the time t at which the change point occurs is set as a condition necessary for the satellite image. For example, when the environmental condition is a weather condition, a satellite image captured when the environmental condition is the closest to a temperature and weather of the place a at the time t is set as a condition necessary for the satellite image.

Furthermore, when the environmental condition is the incident angle of the sun light, a satellite image obtained when the incident angle of the sun light is an incident angle similar to or the closest to the incident angle at the place a and at the time t is set as a condition necessary for the satellite image. In the vegetation index for agriculture and the like, since the characteristics change depending on the incident conditions of the sun light, it is important that the incident angles are the same. In this case, a satellite image captured at the same incident angle even when the dates are different is set as a condition necessary for the satellite image.

Note that, in addition to the necessary condition based on a time, a place, or an environmental condition, it is assumed that a condition necessary for the camera of the satellite 21 is provided as a precondition of the satellite image, such as reserving power (resolution) and an observation width of the mounted camera, monochrome, color, a band (wavelength range) of visible light or non-visible light, and a synthetic aperture radar (SAR).

In step S45, the analysis processing unit 81 requests the satellite image management system 12 to transmit a satellite image satisfying the condition and acquires the satellite image.

Since the processing of the next step S46 is processing executed as necessary and may be omitted, steps S47 and S48 will be described first.

In step S47, the analysis processing unit 81 analyzes the ground data on the basis of the ground data at the time t at which the change point occurs and the acquired satellite image. In a case where a variable for obtaining a desired solution is insufficient only with the ground data, a solution can be obtained by using a macro parameter obtained by analysis of the satellite image.

In step S48, the analysis processing unit 81 outputs the analysis result to its own display unit 85, the terminal device of the end user, or the like, and ends the second analysis processing.

Processing in step S46 will be described.

The basic second analysis processing omitted in step S46 is processing of requesting the satellite image satisfying the condition to the satellite image management system 12 and analyzing the ground data by using the acquired satellite image as it is.

On the other hand, since the acquired satellite image does not completely satisfy the conditions such as the place a and the time t, the second analysis processing in a case where step S46 is performed is processing of generating the satellite image at the time t by estimation and analyzing the ground data by using the generated satellite image.

In step S46, processing of generating a satellite image at the time t at which the change point occurs by estimation is performed on the basis of the acquired satellite image.

For example, in a case where the satellite image acquired in step S45 is not the satellite image at the time t, the analysis processing unit 81 calculates an estimation value of the satellite image at the time t from the satellite image at times t1, t2, ••• acquired in step S45 (t≠t1, t2, •••). The satellite image from which the estimation value of the satellite image at the time t can be easily calculated may be acquired in step S45 described above.

Furthermore, for example, in a case where the satellite image acquired in step S45 is not the place a, the analysis processing unit 81 calculates an estimation value of the satellite image at the place a from the satellite image at places a1, a2, ••• acquired in step S45 (a≠a1, a2, •••). The ground data from which the estimation value of the satellite image at the place a can be easily calculated may be acquired in step S45 described above.

Furthermore, for example, in a case where the environmental condition of the satellite image acquired in step S45 is different, the analysis processing unit 81 calculates an estimation value of the satellite image under a desired environmental condition. The satellite image from which the estimation value of the satellite image under the desired environmental condition can be easily calculated may be acquired in step S45 described above.

In step S47 in a case where the processing in step S46 is executed, the analysis processing unit 81 analyzes the ground data on the basis of the ground data at the time t at which the change point occurs and the satellite image generated by estimation. Then, in step S48, the analysis result is output, and the second analysis processing ends.

In step S45 described above, in a case where there is a plurality of satellite images satisfying the condition, the analysis processing unit 81 may acquire the most reliable satellite image as representative data and use the acquired satellite image as complementary data. Alternatively, an average value or a median value of a plurality of satellite images satisfying the condition may be calculated and used as the complementary data.

### 11. Modification Example of Second Analysis Processing

Next, the modification example of the second analysis processing will be described.

In the second analysis processing described with reference to FIG. 14, the data analysis apparatus 41 acquires a satellite image corresponding to the time t at which the change point occurs from among the satellite images captured in the past, and analyzes the ground data.

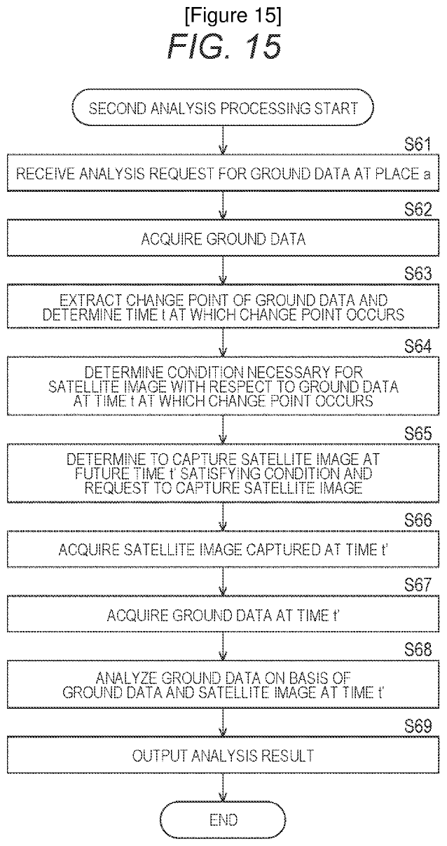

On the other hand, in the modification example of the second analysis processing illustrated in FIG. 15, the data analysis apparatus 41 acquires a satellite image at a future time t′ corresponding to the time t at which the change point occurs as complementary data and analyzes the ground data.

The modification example of the second analysis processing will be described with reference to a flowchart in FIG. 15. For example, this processing is started when an analysis request for the ground data at a predetermined place a is transmitted from (the terminal device of) the end user of the data analysis service.

First, in step S61, the analysis processing unit 81 of the data analysis apparatus 41 receives an analysis request for the ground data at the place a from (the terminal device of) the end user of the data analysis service. The analysis request is for an analysis of the state of the ground data in the past predetermined period at the place a.

In step S62, the analysis processing unit 81 acquires, from the ground data management system 31, the ground data in the past predetermined period specified by the analysis request.

In step S63, the analysis processing unit 81 analyzes the acquired ground data in a predetermined period. For example, the analysis processing unit 81 extracts a time point at which a great change occurs in time-series data of the ground data, a time point at which the ground data reaches a certain value, or the like as a change point, and determines a time t at which the change point occurs. The time t at which the change point occurs may be a specific time indicating one time point of discrete data, or may be a period (time zone) having a certain width.

In step S64, the analysis processing unit 81 determines a condition necessary for the satellite image with respect to the ground data at the time t at which the change point occurs.

In step S65, the analysis processing unit 81 determines to capture a satellite image at the future time t′, which satisfies the condition, and make a request to the satellite travel management system 11. That is, in a case where there is a possibility that a change or an event similar to that at the time t will be reproduced in the future, the analysis processing unit 81 specifies a time t′ at which the reproduction is predicted and a satellite 21 satisfying a condition necessary for the satellite image, and requests the satellite travel management system 11 to perform imaging at the designated time t′ with the specified satellite 21.

The satellite travel management system 11 transmits an imaging instruction to a predetermined satellite 21 via the communication device 13 in accordance with the request for capturing the satellite image. The satellite image that is captured by the specified satellite 21 and satisfies a desired condition is transmitted to the satellite image management system 12, and further transmitted from the satellite image management system 12 to the data analysis apparatus 41.

In step S66, the analysis processing unit 81 acquires a satellite image captured at the time t′ from the satellite image management system 12.

In step S67, the analysis processing unit 81 acquires ground data at the time t′ from the ground data management system 31. That is, the processing of step S67 is processing of acquiring again the ground data at a timing of the time t′ in accordance with a satellite image at a newly acquired time t′. The processing of step S67 can be executed as necessary, and may be omitted. For example, in a case where a change is not predicted in the ground data between the time t at which the change is detected and the time t′ at which the ground data is newly acquired, the acquisition at the time t′ may be omitted. On the other hand, even in a case where the change in the ground data is not predicted, the ground data at the time t′ may be acquired in the sense of aligning the acquisition timing of the data.

In step S68, the analysis processing unit 81 analyzes the ground data on the basis of the ground data and the satellite image at the time t′. The ground data used here is the ground data at the time t′ in a case where step S67 is executed, and is the ground data at the time t in a case where step S67 is omitted.

In step S69, the analysis processing unit 81 outputs the analysis result to its own display unit 85, or the terminal device of the end user, or the like, and ends the second analysis processing.

In the second analysis processing and the modification example thereof, which are described above, a period during which the ground data is acquired is set as a predetermined period in the past, but the data analysis apparatus 41 may acquire ground data from the ground data management system 31 in real time, analyze the ground data in real time, and extract a change point. Then, in a case where the change point is extracted, a condition necessary for the satellite image may be immediately determined and imaging may be requested. In a case where the real-time is emphasized, the analysis processing on the ground data is not necessarily performed by the data analysis apparatus 41, and may be performed by a device closer to the sensor device 33, for example, the ground data management system 31 or the control device 61 including the sensor device 33. The analysis processing on the ground data may be executed by a cloud server.

Note that, in a case where the ground data is acquired by the store-and-forward scheme described in FIG. 7, the timing at which the data analysis apparatus 41 acquires the ground data is later than a detection timing of the ground data, and thus, the analysis processing on the ground data cannot be performed in real time.

In the second analysis processing and the modification example thereof, which are described above, as the analysis processing on the ground data acquired in a predetermined period, the change point of the ground data is extracted, and the satellite image corresponding to the time t at which the change point occurs is acquired. However, the analysis of the ground data is not limited to the extraction of the change point. Even in a case where there is no change in the ground data, when there are provided a predetermined time and a predetermined condition (for example, a timing of sunrise, detection of a moving object, a change in weather or temperature, and the like), the ground data may be analyzed on the basis of the ground data obtained when there are provided the predetermined time and the predetermined condition and the corresponding satellite image.

### 12. Specific Example of Second Analysis Processing

A specific example of the second analysis processing will be described.
Agriculture

Environmental data regarding a growth state of a micro plant and regarding a growth of a plant (temperature, soil moisture, and the like) is measured by using the sensor data obtained from the sensor device 33 installed on the ground and the sensor data sensed by the flying drone including the sensor device 33. With analysis using these sample data and environmental data, it is possible to manage watering and fertilizer application, and to predict harvest.

Moreover, by performing analysis using data of the satellite image, it is possible to predict a macro-environmental change and obtain the state of the entire cultivated land. For example, on the basis of the data of the satellite image, it is possible to know the spread status of pests and the environmental change in the entire region including the cultivated land. For example, it is possible to determine that the observation data of the ground data is being affected by cloud by using the satellite image, and on the basis of this information, it is possible to predict harvest in the cultivated land.
Ocean

It is possible to obtain a local state of the ocean by analysis using sensor data obtained by the sensor device 33 installed in the marine buoy or the ship. For example, it is possible to grasp changes in water quality and water temperature, a change in wave height, status of management for the growth state of marine products, a change in the amount of microorganisms in the ocean, and the like.

Moreover, by using the data of the satellite image, it is possible to know a macro-change occurring in a wider range. For example, it is possible to grasp the occurrence of a red tide, a change in the entire sea area (temperature change or the like) based on weather factors, prediction of an ocean current, and the like.

By using a macro variable in addition to the local sensor data, it is possible to estimate a cause of the change in the sensed local region and predict a future change.
Ship Monitoring

By analyzing AIS information as sensor data, it is possible to grasp the route of a specific ship and the ocean state in the route based on the sensing of the ship.

Moreover, by analyzing the satellite images in combination, it is possible to estimate and specify a factor of a change detected by sensing. For example, data about events occurring in a macro sea area, such as the wave status of the sea obtained by using wave height information from the SAR satellite, a change in seawater temperature, and occurrence of the red tide, are obtained through the analysis of the satellite image, and thus a factor of the change in sensor data can be estimated.
Grasping Traffic Conditions

By using sensor data of the sensor device 33 mounted on a sensor-equipped vehicle and population data detected by an edge device such as a smartphone, it is possible to analyze a change in a traffic volume and a movement volume in a specific region.

Moreover, analysis using the satellite image is performed, and thus it is possible to calculate an accurate traffic volume or the like by using information regarding a vehicle that is not equipped with sensors or a person who does not have an edge device.
City Planning/City Situation

By analyzing the ground data, an event occurring in the city can be observed. For example, the event can be detected from a change in traveling status of a vehicle group, a change in population data, and the like.

By using the data of the satellite image, it is possible to further specify a factor of a regional change. For example, it is possible to detect the appearance of new roads and the appearance of new buildings and to discover accidents and buildings. Even when there is a road with a large traffic volume caused due to the population data, it may be a byroad through which only pedestrians pass, and such a situation can be confirmed using the satellite image to determine whether or not feedback to map information is necessary.
Economic Indicator

Sample data of a specific point can be obtained with analysis using the ground data. For example, it is possible to confirm an increase or decrease in the number of cars at a specific store, an increase or decrease in resource loading amount in a specific harbor, and an increase or decrease in traffic volume in a specific region.

By using the data of the satellite image, it is possible to widely confirm the situation of a remote region, the situation of an entire specific region, and the situation of other regions related to the measurement target company (in particular, a region without sensors), and it is possible to calculate the economic index of a specific company, a specific region, or the like.

As described above, according to the second data analysis processing of analyzing the ground data by using the analysis data of the satellite image (satellite image data) as complementary data, it is possible to select the satellite image suitable for analysis of the ground data and to increase the analysis accuracy for the ground data.

### 13. Another Analysis Processing Example

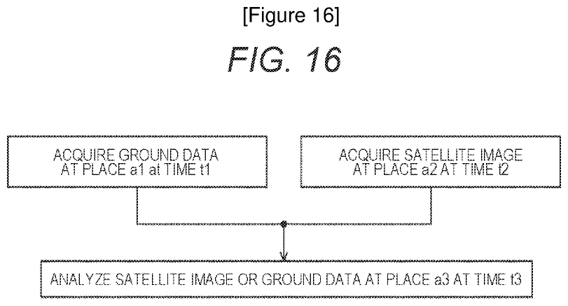

FIG. 16 is a diagram illustrating an application example of the first and second analysis processing described above.

As for the ground data, ground data at a place a1 and at a time t1 is acquired.

As for the satellite image, a satellite image of a place a2 at a time t2 is acquired.

The analysis processing unit 81 of the data analysis apparatus 41 can analyze a satellite image of a place a3 at a time t3 or analyze the ground data at the place a3 and at the time t3 by using the ground data at the place a1 and at the time t1 and the satellite image of the place a2 at the time t2.

Even in a case where there is no data related to a time or a place, analysis processing is performed by combining ground data from a micro viewpoint and a satellite image from a macro viewpoint, and thus the analysis accuracy for the satellite image or ground data of the place a3 at the time t3 can be improved.

### 14. Computer Configuration Example

The above-described series of processing can be executed by hardware or software. In a case where the series of processing is executed by the software, a program that configures the software is installed in a computer. Here, examples of the computer include, for example, a microcomputer that is built in dedicated hardware, a general-purpose personal computer that can perform various functions by being installed with various programs, and the like.

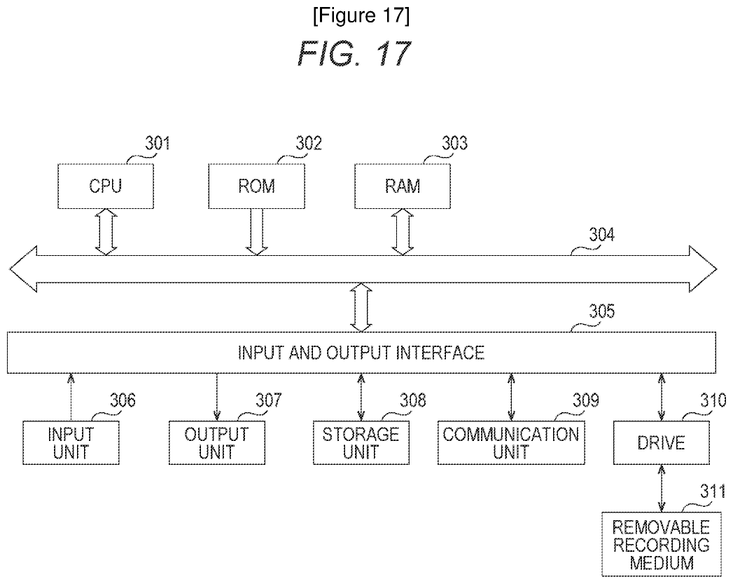

FIG. 17 is a block diagram illustrating a configuration example of the hardware of the computer that executes the above-described series of processing with a program.

In the computer, a central processing unit (CPU) 301, a read only memory (ROM) 302, and a random access memory (RAM) 303 are connected to each other by a bus 304.

An input and output interface 305 is also connected to the bus 304. An input unit 306, an output unit 307, a storage unit 308, a communication unit 309, and a drive 310 are connected to the input and output interface 305.

The input unit 306 includes a keyboard, a mouse, a microphone, a touch panel, and an input terminal. The output unit 307 includes a display, a speaker, and an output terminal. The storage unit 308 includes a hard disk, a RAM disk, and a nonvolatile memory. The communication unit 309 includes a network interface. The drive 310 drives a removable recording medium 311 such as a magnetic disk, an optical disk, a magneto-optical disk, or a semiconductor memory.

In the computer configured as described above, for example, the CPU 301 loads the program stored in the storage unit 308 into the RAM 303 via the input and output interface 305 and the bus 304 and executes the program, and thus the above-described series of processing is performed. Furthermore, the RAM 303 also appropriately stores data and the like necessary when the CPU 301 executes various processing.

The program executed by the computer (CPU 301) can be provided by being recorded on, for example, the removable recording medium 311 as a package medium or the like. Furthermore, the program can be provided via a wired or wireless transmission medium such as a local area network, the Internet, or digital satellite broadcasting.

In the computer, the removable recording medium 311 is attached to the drive 310, and thus the program can be installed in the storage unit 308 via the input and output interface 305. Furthermore, the program can be received by the communication unit 309 via a wired or wireless transmission medium, and installed on the storage unit 308. In addition, the program can be installed in advance on the ROM 302 and the storage unit 308.

In this specification, the steps described in the flowcharts may be performed in time series according to the described order as a matter of course, but are not necessarily performed in time series, and may be executed in parallel or at necessary timing such as when a call is made.

Furthermore, in the present specification, the system means a set of a plurality of components (devices, modules (parts), and the like), and it does not matter whether or not all the components are in the same housing. Therefore, a plurality of devices housed in separate housings and connected via a network and one device in which a plurality of modules is housed in one housing are both systems.

An embodiment of the present technology is not limited to the above-described embodiments, and various modifications can be made without departing from the gist of the present technology.

For example, the present technology can have a configuration of cloud computing in which one function is shared and processed in cooperation by a plurality of devices via a network.

Furthermore, each step described in the above-described flowcharts can be executed by one device or can be shared and executed by a plurality of devices.

Moreover, in a case where a plurality of processing is included in one step, a plurality of the processing included in one step can be executed by one device or can be shared and executed by a plurality of devices.

Note that the effects described in the present specification are merely examples and are not limited, and effects other than those described in the present specification may be provided.

Note that the present technology can also have the following configurations.

(1)

A data analysis apparatus including:

a data acquisition unit configured to acquire a satellite image obtained by an artificial satellite imaging a predetermined place on a ground at a predetermined time and acquire ground data corresponding to a condition for capturing the satellite image from the ground data acquired on the ground; and

an analysis processing unit configured to analyze the satellite image by using the acquired ground data and the acquired satellite image.

(2)

The data analysis apparatus according to (1),

in which the data acquisition unit acquires, as the ground data corresponding to the condition for capturing the satellite image, ground data at a time close to the predetermined time at which the artificial satellite performs imaging.

(3)

The data analysis apparatus according to (1),

in which the data acquisition unit acquires, as the ground data corresponding to the condition for capturing the satellite image, ground data at a place close to the predetermined place at which the artificial satellite performs imaging.

(4)

The data analysis apparatus according to (1),

in which the data acquisition unit acquires, as the ground data corresponding to the condition for capturing the satellite image, ground data close to an environmental condition when the artificial satellite performs imaging.

(5)

The data analysis apparatus according to (4),

in which the environmental condition is a weather condition.
(6)

The data analysis apparatus according to (4),

in which the environmental condition is an incident condition of sun light.

(7)

The data analysis apparatus according to (1) or (2),

in which the analysis processing unit estimates, from the acquired ground data, ground data at the predetermined time at which the artificial satellite performs imaging, and analyzes the satellite image on the basis of the estimated ground data and the satellite image.

(8)

The data analysis apparatus according to (1) or (3),

in which the analysis processing unit estimates, from the acquired ground data, ground data at the predetermined place at which the artificial satellite performs imaging, and analyzes the satellite image on the basis of the estimated ground data and the satellite image.

(9)

The data analysis apparatus according to (1) or (4),

in which the analysis processing unit estimates, from the acquired ground data, ground data under an environmental condition when the artificial satellite performs imaging, and analyzes the satellite image on the basis of the estimated ground data and the satellite image.

(10)

The data analysis apparatus according to any one of (1) to (9),

in which the data acquisition unit acquires a plurality of pieces of the ground data, and

the analysis processing unit analyzes the satellite image on the basis of ground data obtained by performing data processing on a plurality of pieces of the acquired ground data and the satellite image.

(11)

The data analysis apparatus according to (1),

in which the analysis processing unit determines whether or not imaging with a second artificial satellite different from the artificial satellite which has performed imaging first is necessary, on the basis of an analysis result obtained by using the acquired ground data and the acquired satellite image.

(12)

The data analysis apparatus according to (11),

in which in a case where it is determined that the second artificial satellite needs to perform imaging, the analysis processing unit requests the second artificial satellite to perform the imaging.

(13)

The data analysis apparatus according to any one of (1) to (12),

in which the analysis processing unit corrects the analysis result of the satellite image by using the acquired ground data.

(14)

The data analysis apparatus according to (13),

in which the analysis processing unit changes weighting of a correction degree according to a degree of coincidence of the condition of the acquired ground data.

(15)

The data analysis apparatus according to any one of (1) to (14),

in which the ground data is data acquired by a sensor device on the ground.

(16)

The data analysis apparatus according to any one of (1) to (15),

in which the ground data is data collected through a store-and-forward scheme.

(17)

A data analysis method causing a data analysis apparatus to:

acquire a satellite image obtained by an artificial satellite imaging a predetermined place on a ground at a predetermined time and acquire ground data corresponding to a condition for capturing the satellite image from the ground data acquired on the ground; and

analyze the satellite image by using the acquired ground data and the acquired satellite image.

(18)

A program causing a computer to execute processing, the processing including:

acquiring a satellite image obtained by an artificial satellite imaging a predetermined place on a ground at a predetermined time and acquiring ground data corresponding to a condition for capturing the satellite image from the ground data acquired on the ground; and

analyzing the satellite image by using the acquired ground data and the acquired satellite image.

### REFERENCE SIGNS LIST

1 Satellite image processing system
11 Satellite travel management system
12 Satellite image management system
16 Satellite management system
21 Artificial satellite (satellite)
31A, 31B Ground data management system
33 Sensor device
41 Data analysis apparatus
51 Sensor unit
61 Control device
81 Analysis processing unit
82 Control unit
301 CPU
302 ROM
303 RAM
306 Input unit
307 Output unit
308 Storage unit
309 Communication unit
310 Drive

1. A data analysis apparatus comprising:
a data acquisition unit configured to acquire a satellite image obtained by an artificial satellite imaging a predetermined place on a ground at a predetermined time and acquire ground data corresponding to a condition for capturing the satellite image from the ground data acquired on the ground; and
an analysis processing unit configured to analyze the satellite image by using the acquired ground data and the acquired satellite image.

2. The data analysis apparatus according to claim 1,
wherein the data acquisition unit acquires, as the ground data corresponding to the condition for capturing the satellite image, ground data at a time close to the predetermined time at which the artificial satellite performs imaging.

3. The data analysis apparatus according to claim 1,
wherein the data acquisition unit acquires, as the ground data corresponding to the condition for capturing the satellite image, ground data at a place close to the predetermined place at which the artificial satellite performs imaging.

4. The data analysis apparatus according to claim 1,
wherein the data acquisition unit acquires, as the ground data corresponding to the condition for capturing the satellite image, ground data close to an environmental condition when the artificial satellite performs imaging.

5. The data analysis apparatus according to claim 4,
wherein the environmental condition is a weather condition.

6. The data analysis apparatus according to claim 4,
wherein the environmental condition is an incident condition of sun light.

7. The data analysis apparatus according to claim 1,
wherein the analysis processing unit estimates, from the acquired ground data, ground data at the predetermined time at which the artificial satellite performs imaging, and analyzes the satellite image on a basis of the estimated ground data and the satellite image.

8. The data analysis apparatus according to claim 1,
wherein the analysis processing unit estimates, from the acquired ground data, ground data at the predetermined place at which the artificial satellite performs imaging, and analyzes the satellite image on a basis of the estimated ground data and the satellite image.

9. The data analysis apparatus according to claim 1,
wherein the analysis processing unit estimates, from the acquired ground data, ground data under an environmental condition when the artificial satellite performs imaging, and analyzes the satellite image on a basis of the estimated ground data and the satellite image.

10. The data analysis apparatus according to claim 1,
wherein the data acquisition unit acquires a plurality of pieces of the ground data, and
the analysis processing unit analyzes the satellite image on a basis of ground data obtained by performing data processing on a plurality of pieces of the acquired ground data and the satellite image.

11. The data analysis apparatus according to claim 1,
wherein the analysis processing unit determines whether or not imaging with a second artificial satellite different from the artificial satellite which has performed imaging first is necessary, on a basis of an analysis result obtained by using the acquired ground data and the acquired satellite image.

12. The data analysis apparatus according to claim 11,
wherein in a case where it is determined that the second artificial satellite needs to perform imaging, the analysis processing unit requests the second artificial satellite to perform the imaging.

13. The data analysis apparatus according to claim 1,
wherein the analysis processing unit corrects the analysis result of the satellite image by using the acquired ground data.

14. The data analysis apparatus according to claim 13,
wherein the analysis processing unit changes weighting of a correction degree according to a degree of coincidence of the condition of the acquired ground data.

15. The data analysis apparatus according to claim 1,
wherein the ground data is data acquired by a sensor device on the ground.

16. The data analysis apparatus according to claim 1,
wherein the ground data is data collected through a store-and-forward scheme.

17. A data analysis method causing a data analysis apparatus to:
acquire a satellite image obtained by an artificial satellite imaging a predetermined place on a ground at a predetermined time and acquire ground data corresponding to a condition for capturing the satellite image from the ground data acquired on the ground; and
analyze the satellite image by using the acquired ground data and the acquired satellite image.

18. A program causing a computer to execute processing, the processing comprising:
acquiring a satellite image obtained by an artificial satellite imaging a predetermined place on a ground at a predetermined time and acquiring ground data corresponding to a condition for capturing the satellite image from the ground data acquired on the ground; and
analyzing the satellite image by using the acquired ground data and the acquired satellite image.
